(19) United States
(12) Patent Application Publication
(10) Pub. No.: US 2012/0300027 A1
(43) Pub. Date: Nov. 29, 2012

(54) STEREOSCOPIC IMAGE DISPLAY DEVICE

(75) Inventor: Takayoshi URISU, Osaka (JP)

(73) Assignee: FUNAI ELECTRIC CO., LTD., Osaka (JP)

(21) Appl. No.: 13/456,224

(22) Filed: Apr. 26, 2012

(30) Foreign Application Priority Data
May 24, 2011 (JP) 2011-115591

(51) Int. Cl. H04N 13/00

(52) U.S. Cl. 348/43; 348/E13.068

(57) ABSTRACT

The present invention discloses a stereoscopic image display device includes a 3D output processing unit, a format matching judging unit and a time out unit. The 3D output processing unit receives a selection of a 3D (3-Dimensional) mode as an output format, and changes an output mode to the 3D mode and starts outputting a 3D (3-Dimensional) image based on the selected output format if the selection of the 3D mode is received while an image is output in a 2D (2-Dimensional) mode. The format matching judging unit judges a matching between the output format and a format of the image input to the stereoscopic image display device. The time out unit stops outputting the image in the 3D mode to return the output mode to the 2D mode if the format matching judging unit detects a mismatching of the format.

### CROSS-REFERENCES TO RELATED APPLICATIONS

The present application is related to the Japanese Patent Application No. 2011-115591, filed May 24, 2011, the entire disclosure of which is expressly incorporated by reference herein.

### BACKGROUND OF THE INVENTION

1. Field of the Invention:

The present invention relates to a stereoscopic image display device that can switch an output mode from a 2D (2-Dimensional) mode to a 3D (3-Dimensional) mode, and output a 3D image based on an output format of the 3D mode.

2. Description of the Related Art:

These days, an image display device such as a 3D television that can display both a 2D (2-Dimensional) image and a 3D (3-Dimensional) image is sold. In an image source such as television broadcasting, the 2D image and the 3D image may be mixed. For example, a program is broadcasted as the 3D image and a commercial message is broadcasted as the 2D image. Technologies to switch 2D/3D images by identifying the type of the image or to provide appropriate image information by generating 2D/3D images according to the viewer's environment are disclosed in the following documents:
Japanese Patent Application Publication 2010-258848
Japanese Patent Application Publication 2011-028791
Japanese Patent Application Publication 2010-288234
Japanese Patent Application Publication 2004-343290
Japanese Patent Application Publication 2011-029701

For example, the 3D television is composed of two chips: a SoC (System on Chip) that carries out various image processing such as a brightness control and a contrast control, and a FRC (Frame Rate Converter) that converts a frame rate. The SoC superimposes an OSD (On Screen Display) image on the image. As for the 3D television, 3D images having a format such as a Side by Side format (hereafter abbreviated as SbyS), a Top & Bottom format (hereafter abbreviated as T&B), and an HDMI 1.4 Frame Packing format (hereafter abbreviated as HDMI) are input.

If a user sets a wrong 3D output mode, the user cannot view the 3D images and the OSD (On Screen Display) images. Accordingly, the user may not be able to exit from the wrong setting of the 3D output mode.

### BRIEF SUMMARY OF THE INVENTION

The present invention discloses a stereoscopic image display device that enables the user to avoid the situation where the user cannot view the OSD images even when the setting of the 3D output mode is not correct.

One aspect of the present invention provides a stereoscopic image display device comprising:
a 3D output processing unit that receives a selection of a 3D (3-Dimensional) mode as an output format, and changes an output mode to the 3D mode and starts outputting a 3D (3-Dimensional) image based on the selected output format if the selection of the 3D mode is received while an image is output in a 2D (2-Dimensional) mode;
a format matching judging unit that judges a matching between the output format and a format of the image input to the stereoscopic image display device; and
a time out unit that stops outputting the image in the 3D mode to return the output mode to the 2D mode if the format matching judging unit detects a mismatching of the format.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

FIG. 1 is an exemplary illustration of a block diagram showing main sections of a 3D television.

FIG. 2 is an example of a 3D output mode setting screen.

FIG. 3 is an exemplary illustration of a flow chart showing a process of judging an output format in the first embodiment.

FIG. 4 is an exemplary illustration that explains an example of judging an output format.

FIG. 5 is an exemplary illustration of a flow chart showing a process of judging an output format in the second embodiment.

FIG. 6 is an exemplary illustration that shows an example of a predefined OSD image.

FIG. 7 is an exemplary illustration that explains an image processing of the SbyS.

FIG. 8 is an exemplary illustration that explains an image processing of the T&B.

FIG. 9 is an exemplary illustration that explains an image processing of the HDMI.

FIG. 10 is an exemplary illustration that explains a comparative example when an input 3D image is the T&B while the setting of the 3D output mode is set to the SbyS.

FIG. 11 is an exemplary illustration that explains a comparative example when an input 3D image is the SbyS while the setting of the 3D output mode is set to the T&B.

FIG. 12 is an exemplary illustration that explains a comparative example when an input 3D image is the HDMI while the setting of the 3D output mode is set to the SbyS.

FIG. 13 is an exemplary illustration that explains a comparative example when an input 3D image is the HDMI while the setting of the 3D output mode is set to the T&B.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

An embodiment of the present invention will be described below. It goes without saying that the below-described embodiment merely exemplifies the present invention.

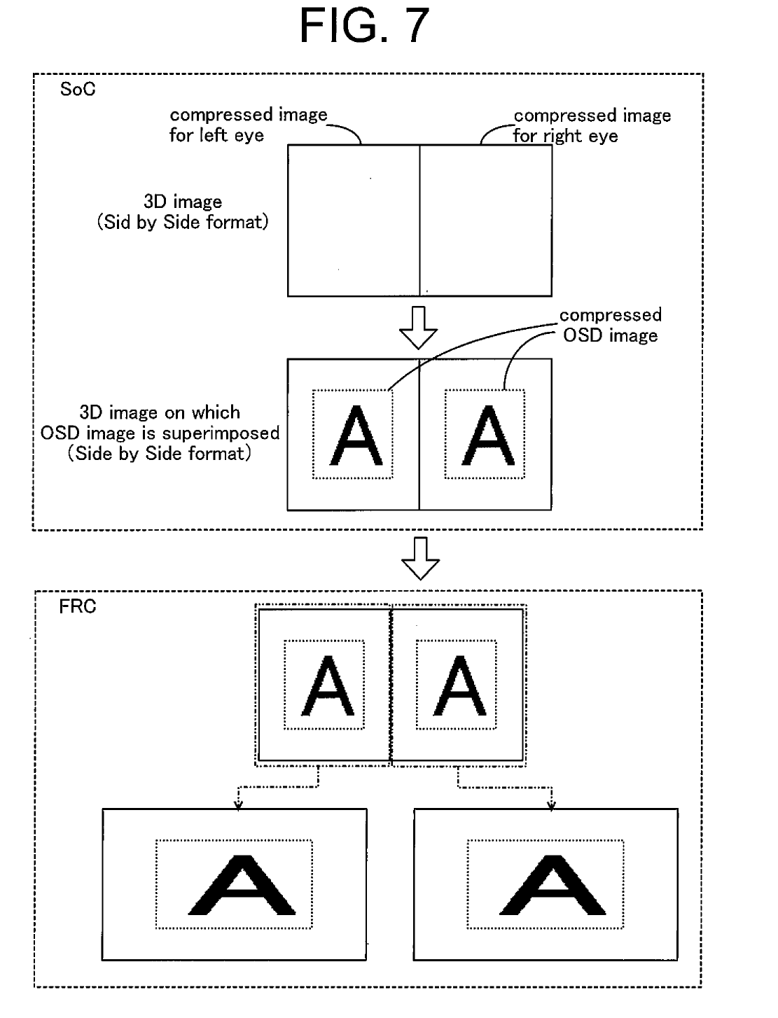

FIG. 7 is an exemplary illustration that explains an image processing of the SbyS. As shown in FIG. 7, in a 3D image of the SbyS, a frame image (hereafter SbyS frame image) is composed by horizontally aligning a compressed image for left eye that is compressed to half width and a compressed image for right eye that is compressed to half width. The SoC carries out various image processing to the frame image and then outputs the frame image to the FRC.

If the SoC is instructed to superimpose the OSD image while inputting the SbyS frame image, the SoC generates a compressed OSD image that is compressed to half width. The SoC superimposes the compressed OSD image to a predefined position of the compressed image for left eye and a predefined position of the compressed image for right eye respectively, and then outputs the SbyS frame image on which the OSD image is superimposed to the FRC.

The FRC reproduces the image for left eye by clipping the left half of the SbyS frame image and doubling the width of it, and reproduces the image for right eye by clipping the right half of the SbyS frame image and doubling the width of it. The reproduced images for left eye and for right eye are output alternately in an active system. On the other hand, the reproduced images are divided into horizontal lines and then odd/even lines are aligned and output to left/right eyes respectively in a passive system.

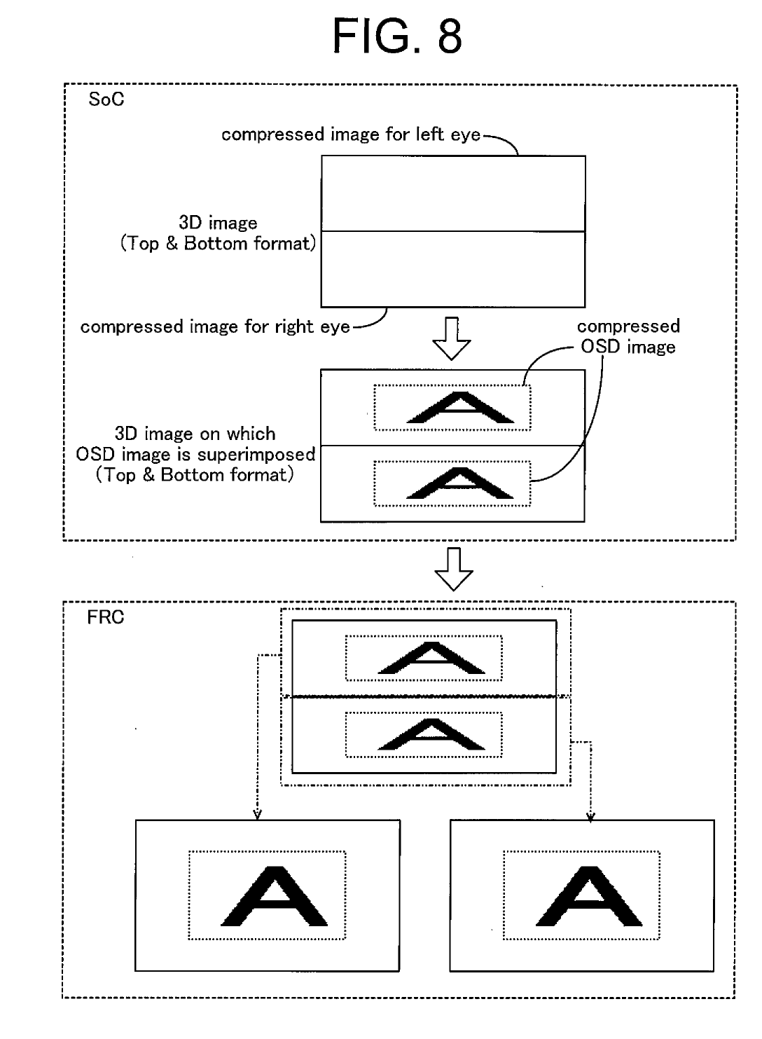

FIG. 8 is an exemplary illustration that explains an image processing of the T&B. As shown in FIG. 8, in a 3D image of the T&B, a frame image (hereafter T&B frame image) is composed by vertically aligning a compressed image for left eye that is compressed to half height and a compressed image for right eye that is compressed to half height. The SoC carries out various image processing to the frame image and then outputs the frame image to the FRC.

If the SoC is instructed to superimpose the compressed OSD image while inputting the T&B frame image, the SoC generates a compressed OSD that is compressed to half height. The SoC superimposes the compressed OSD image to a predefined position of the compressed image for left eye and a predefined position of the compressed image for right eye respectively, and then outputs the T&B frame image on which the OSD image is superimposed to the FRC.

The FRC reproduces the image for left eye by clipping the upper half of the T&B frame image and doubling the height of it, and reproduces the image for right eye by clipping the lower half of the T&B frame image and doubling the height of it. The reproduced images for left eye and for right eye are output alternately in an active system. On the other hand, the reproduced images are divided into horizontal lines and then odd/even lines are aligned and output to left/right eyes respectively in a passive system.

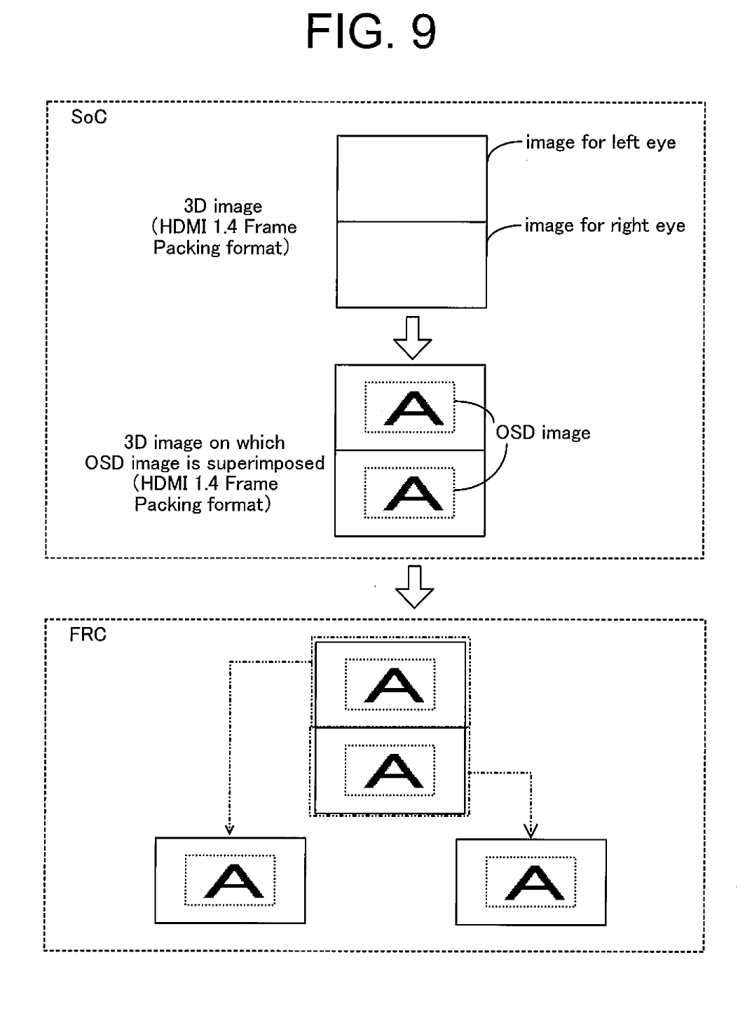

FIG. 9 is an exemplary illustration that explains an image processing of the HDMI. As shown in FIG. 9, in a 3D image of the HDMI, a frame image (hereafter HDMI frame image) is composed by vertically aligning an image for left eye that has a normal height and an image for right eye that has a normal height. Consequently, the height of the HDMI frame image is doubled as normal. The SoC carries out various image processing to the frame image and then outputs the frame image to the FRC.

If the SoC is instructed to superimpose the OSD image while inputting the HDMI frame image, the SoC generates the OSD image, then superimposes the OSD image on a predefined position of the image for left eye and a predefined position of the image for right eye respectively, and then outputs the HDMI frame image on which the OSD image is superimposed to the FRC.

The FRC reproduces the image for left eye by clipping the upper half of the HDMI frame image, and reproduces the image for right eye by clipping the lower half of the HDMI frame image. The reproduced images for left eye and for right eye are output alternately in an active system. On the other hand, the reproduced images are divided into horizontal lines and then odd/even lines are aligned and output to left/right eyes respectively in a passive system.

Here, the SoC has a means to judge the format of the input 3D image (SbyS, T&B, or HDMI), and thus the SoC can superimpose the OSD image on the appropriate position according to the format of the input 3D image. The FRC generates the image for left eye and the image for right eye according to the setting of the 3D output mode input from the user by using an operating section such as a remote controller. In other words, if the 3D output mode is set to the SbyS, the FRC reproduces the image for left eye by clipping the left half of the frame image and doubling the width of it, and reproduces the image for right eye by clipping the right half of the frame image and doubling the width of it. In addition, if the 3D output mode is set to the T&B, the FRC reproduces the image for left eye by clipping the upper half of the frame image and doubling the height of it, and reproduces the image for right eye by clipping the lower half of the frame image and doubling the height of it.

Accordingly, if the setting of the 3D output mode is wrongly set against the correct format of the input 3D image, the following problems may be occurred.

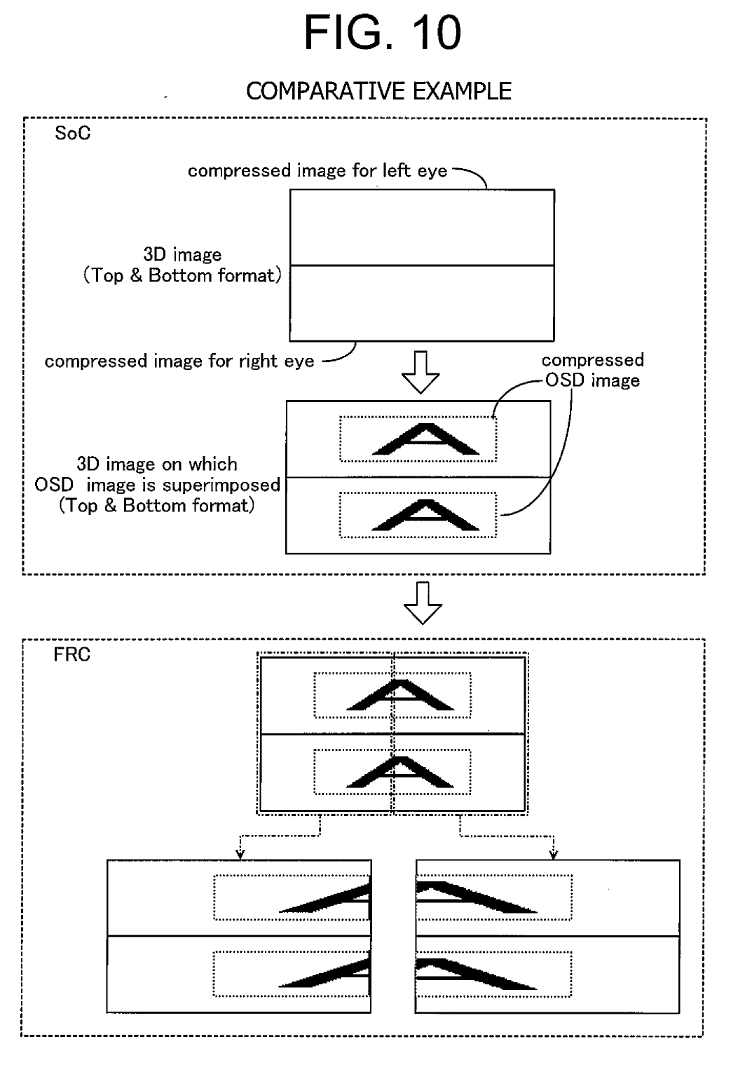

FIG. 10 is an exemplary illustration that explains a comparative example when the input 3D image is the T&B while the setting of the 3D output mode is set to the SbyS. As shown in FIG. 10, the SoC superimposes the OSD image on an appropriate position of the compressed image for left eye and the compressed image for right eye. However, the FRC reproduces the image for left eye by clipping the left half of the T&B frame image and doubling the width of it, and reproduces the image for right eye by clipping the right half of the T&B frame image and doubling the width of it. Accordingly, the 3D image and the OSD image are not properly displayed on the screen and cannot be viewed. In other words, the user cannot understand the content of the OSD image or the like.

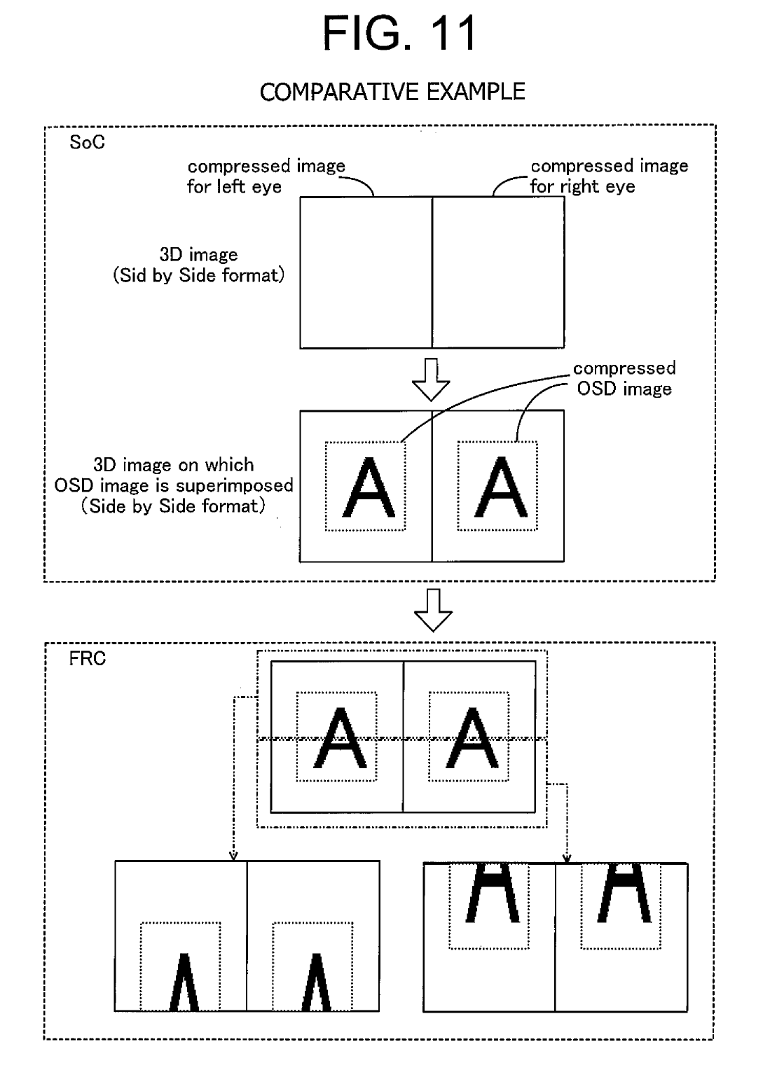

FIG. 11 is an exemplary illustration that explains a comparative example when the input 3D image is the SbyS while the setting of the 3D output mode is set to the T&B. As shown in FIG. 11, the SoC superimposes the OSD image on an appropriate position of the compressed image for left eye and the compressed image for right eye. However, the FRC reproduces the image for left eye by clipping the upper half of the SbyS frame image and doubling the height of it, and reproduces the image for right eye by clipping the lower half of the SbyS frame image and doubling the height of it. Accordingly, the 3D image and the OSD image are not properly displayed on the screen and cannot be viewed.

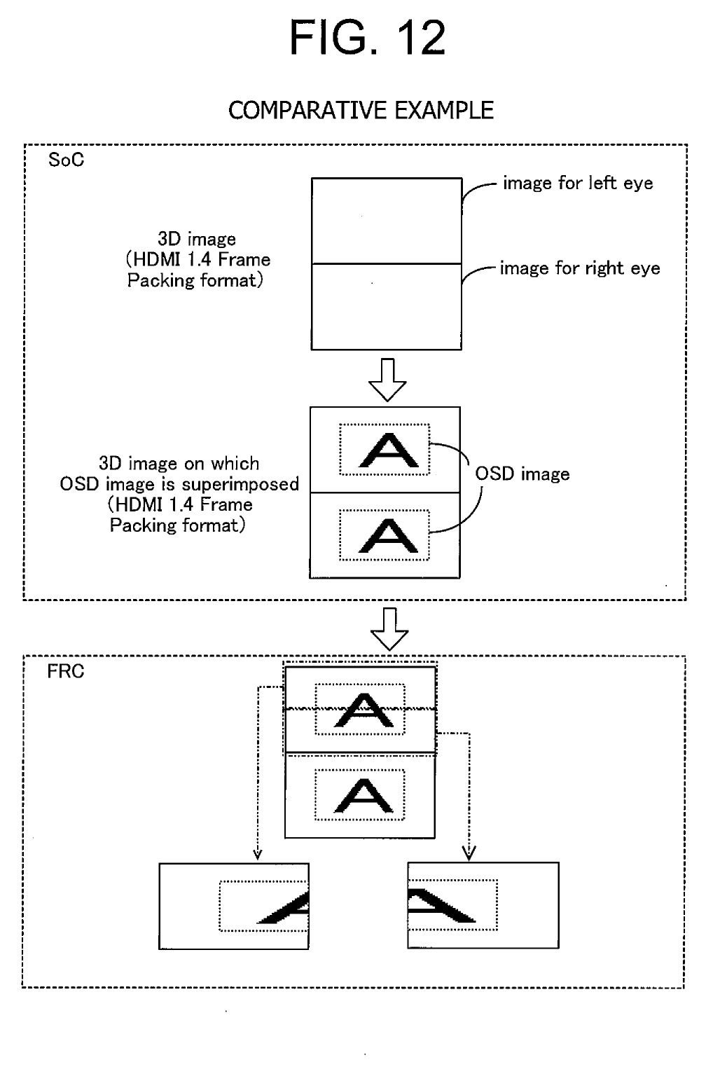

FIG. 12 is an exemplary illustration that explains a comparative example when the input 3D image is the HDMI while the setting of the 3D output mode is set to the SbyS. As shown in FIG. 12, the SoC superimposes the OSD image on an appropriate position of the image for left eye and the image for right eye. However, the FRC reproduces the image for left eye by clipping the left half of the upper half (image for left eye) of the HDMI frame image and doubling the width of it, and reproduces the image for right eye by clipping the right half of the upper half (image for left eye) of the HDMI frame image and doubling the width of it. Accordingly, the 3D image and the OSD image are not properly displayed on the screen and cannot be viewed.

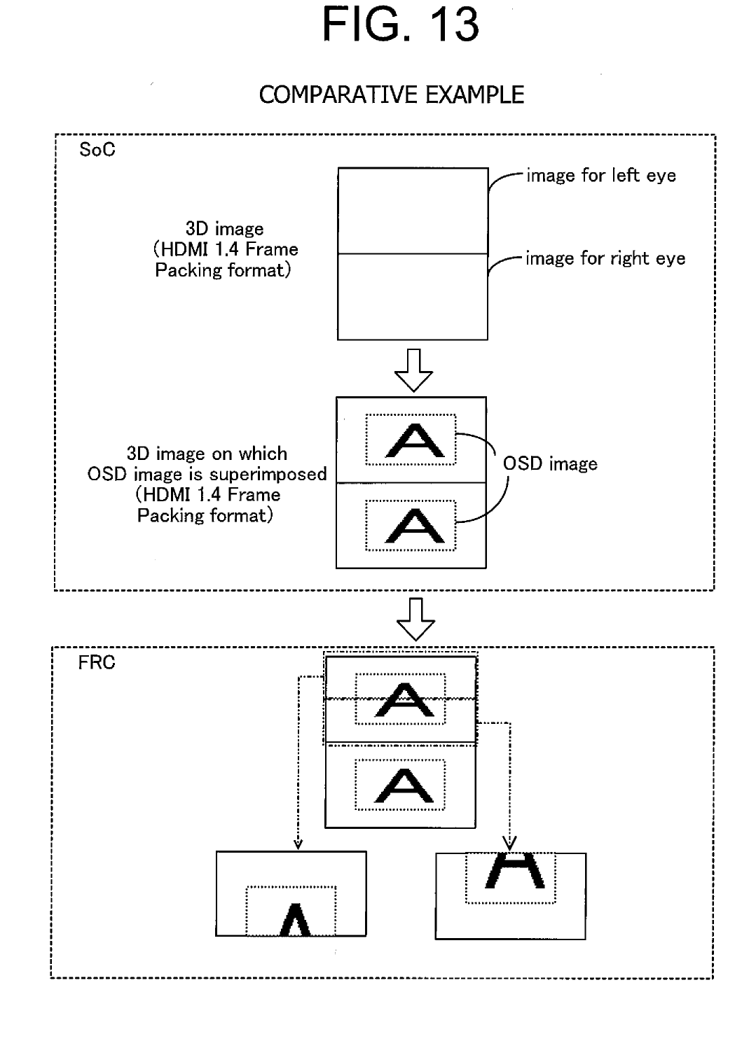

FIG. 13 is an exemplary illustration that explains a comparative example when the input 3D image is the HDMI while the setting of the 3D output mode is set to the T&B. As shown in FIG. 13, the SoC superimposes the OSD image on an appropriate position of the image for left eye and the image for right eye. However, the FRC reproduces the image for left eye by clipping the upper half of the upper half (image for left eye) of the HDMI frame image, and reproduces the image for right eye by clipping the lower half of the upper half (image for left eye) of the HDMI frame image. Accordingly, the 3D image and the OSD image are not properly displayed on the screen and cannot be viewed.

On the other hand, by using the present invention, the user can avoid the situation where the user cannot view the OSD images or cannot recognize the contents of the OSD images even when the setting of the 3D output mode is not correct.

### (First Aspect)

One aspect of the present invention provides a stereoscopic image display device comprising:
a 3D output processing unit that receives a selection of a 3D (3-Dimensional) mode as an output format, and changes an output mode to the 3D mode and starts outputting a 3D (3-Dimensional) image based on the selected output format if the selection of the 3D mode is received while an image is output in a 2D (2-Dimensional) mode;
a format matching judging unit that judges a matching between the output format and a format of the image input to the stereoscopic image display device; and
a time out unit that stops outputting the image in the 3D mode to return the output mode to the 2D mode if the format matching judging unit detects a mismatching of the format.

### (Second Aspect)

Another aspect of the present invention provides a stereoscopic image display device that receives a selection of a 3D mode as an output format, and changes the output format to the 3D mode and starts outputting a 3D image based on the selected output format if the selection of the 3D mode is received while an image is output in a 2D mode, comprising:
a format matching judging unit that judges a matching between the output format and a format of the image input to the stereoscopic image display device; and
a time out unit that fixes the output mode to the 3D mode if format matching judging unit detects a matching of the format and stops outputting the image in the 3D mode to return the output mode to the 2D mode if the format matching judging unit does not detect a matching of the format within a predetermined period.

### (Third Aspect)

An optional aspect of the present invention provides the stereoscopic image display device, wherein:
the format matching judging unit judges the format of the image based on a tag information attached to the image input to the stereoscopic image display device.

According to the third aspect of the present invention, the propriety of the setting of output format can be judged based on the tag information included in the 3D image.

### (Fourth Aspect)

Another optional aspect of the present invention provides the stereoscopic image display device, wherein:
the format matching judging unit compares an area of a frame image where an image for left eye is to be combined in each 3D format and an area of a frame image where an image for right eye is to be combined in each 3D format by considering an parallax amount, and the 3D format that indicates a certain similarity is judged as the format of the image input to the stereoscopic image display device.

According to the fourth aspect of the present invention, the propriety of the setting of output format can be judged by analyzing the 3D image.

### (Fifth Aspect)

Another optional aspect of the present invention provides the stereoscopic image display device, further comprising:
a first image processing chip that adjusts image quality to the 3D image including a frame image in which an image for left eye and an image for right eye are combined; and
a second image processing chip that reproduces the image for left eye and the image for right eye respectively from the 3D image,
wherein
the first image processing chip superimposes an OSD (On Screen Display) image to the frame image; and
the format matching judging unit superimposes the OSD image that inquires whether or not the OSD image can be viewed on an appropriate position according to the format of the image input to the stereoscopic image display device, and the format is judged to match if a certain operation is input within a certain time after the OSD is displayed and the format is judged to mismatch if a certain operation is not input within a certain time after the OSD is displayed.

According to the fifth aspect of the present invention, the propriety of the setting of output format can be judged by inquiring the user whether or not the image can be viewed.

Note that the above described stereoscopic image display device can also be achieved in various ways, by being built into another device or by being carried out together with other methods, for example. In addition, the present invention can also be achieved as a stereoscopic image display system having the above described stereoscopic image display device, a method having the process corresponding to the above described device, a program to let the computer carry out the function corresponding to the above described device, or a computer readable recording media that records the program. The stereoscopic image display system, the method for displaying stereoscopic image, the program for displaying stereoscopic image, and the recording media for displaying stereoscopic image has same functions and effects as the above described device.

### (1) Composition of the Present Embodiment

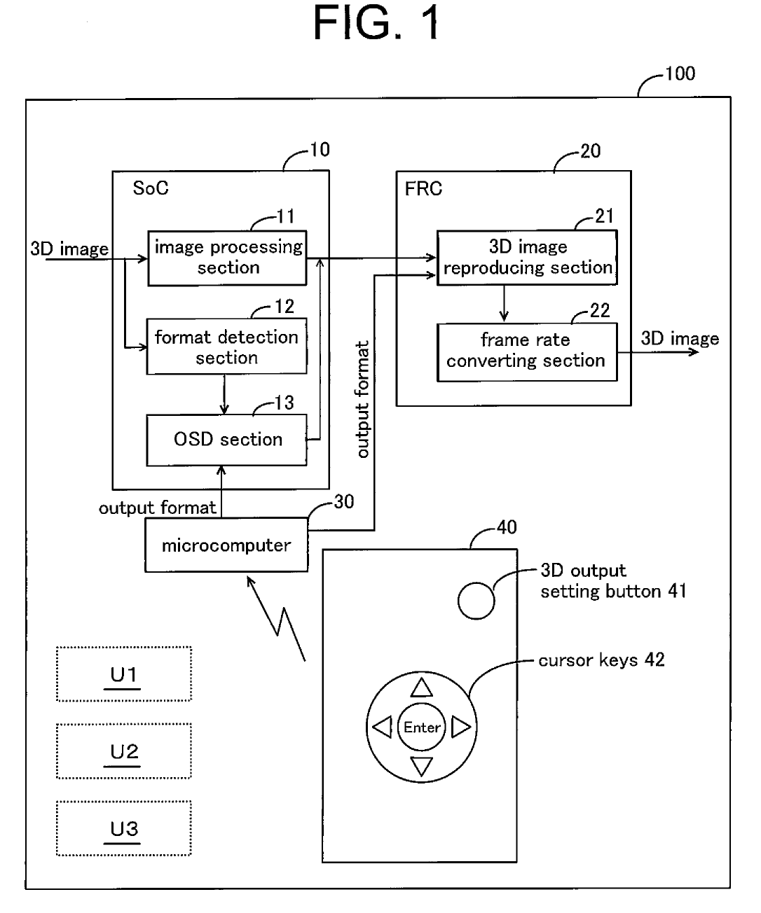

FIG. 1 is an exemplary illustration of a block diagram showing main sections of a 3D television (stereoscopic image display device). The 3D television has a SoC (System on Chip) 10, a FRC (Frame Rate Converter) 20, a microcomputer 30, and a remote controller 40. Here, the SoC 10 is an example of a first image processing chip. The FRC 20 is an example of a second image processing chip. The remote controller 40 is an example of a format reception unit.

The SoC 10 has an image processing section 11, a format detection section 12, and an OSD section 13. The SoC inputs 3D (3-Dimensional) images and 2D (2-Dimensional) images, and carries out various processes without converting the frame rate (e.g. 60 Hz) of the input image. The image processing section 11 carries out various image processing such as the brightness control and a contrast control on the 3D images and 2D images input to the SoC 10. The format detection section 12 acquires tags transmitted during a vertical interval or tags of HDMI InfoFrame, then judges the format of the input image based on the acquired tag information. The OSD section 13 superimposes the OSD images on each frame image of the input image according to the instruction of the microcomputer 30.

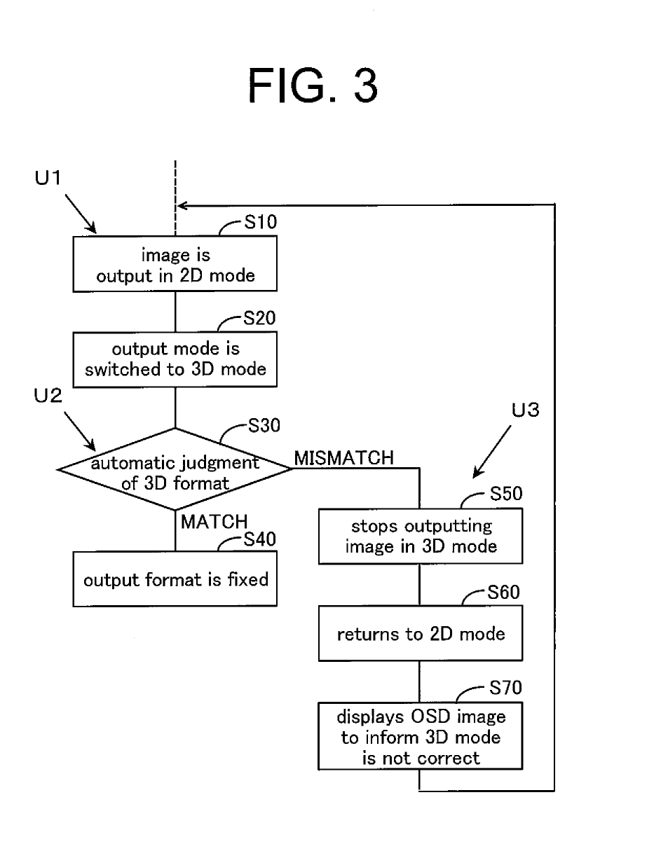

The FRC 20 has a 3D image reproducing section 21 and a frame rate converting section 22. As explained referring to FIGS. 3 to 9, the 3D image reproducing section 21 reproduces the image for left eye and the image for right eye from the frame image on which both images for left eye and right eye are combined, and then sequentially outputs them to the frame rate converting section 22. Note that the 3D image reproducing section 21 outputs the image to the frame rate converting section 22 without executing any processes if the input image is the 2D image.

The microcomputer 30 controls whole the 3D television 100. The remote controller 40 has a 3D output setting button 41 to set the 3D output format in addition to a power button, channel switching buttons, cursor keys 42 and other buttons. The microcomputer 30 has a remote control signal reception section that receives remote control signals output from the remote controller 40, and carries out processes according to the received remote control signals. For example, if the microcomputer 30 receives a signal to indicate the operation of the 3D output setting button 41, the microcomputer 30 instructs the OSD section 13 to display the OSD image concerning the 3D output mode setting screen to select the setting of the 3D output mode.

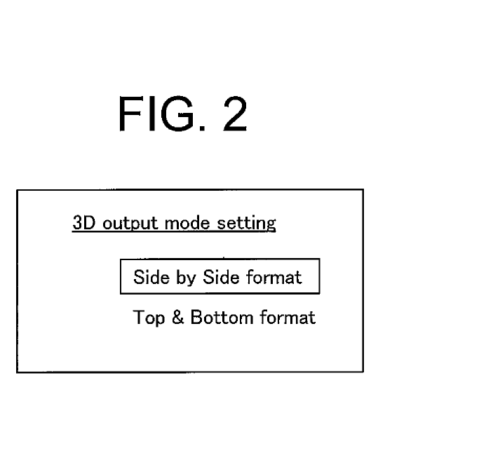

FIG. 2 is an example of the 3D output mode setting screen. In the 3D output mode setting screen shown in FIG. 2, “Side by Side format” or “Top & Bottom format” is selectable as the 3D output mode. The user can select one of the 3D output modes by operating up/down keys of the cursor keys 42 to align the cursor and operating the Enter key. Hereafter, the 3D format corresponding to the 3D output mode selected by the remote controller 40 by the user is described as “output format”. On the other hand, the 3D format concerning the 3D image actually input is described as “input format”.

The 3D image reproducing section 21 receives the information concerning the output format from the microcomputer 30, and reproduces the 3D images according to the output format. In other words, the 3D image reproducing section 21 acquires images from the 3D image according to the combined area of the image for left eye and right eye that is defined in the output format, and then reproduces the images for left eye and right eye by enlarging the acquired image if the output format is the compressed format.

The OSD section 13 shown in FIG. 1 superimposes the OSD (On Screen Display) images on the 3D image based on the format detected from the image by the format detection section 12.

### (2) First Embodiment for Judging an Output Format

FIG. 3 is a flow chart showing a process of judging an output format in the first embodiment. The judgment of the output format (S30) shown in FIG. 3 is executed while the image is output in the 2D mode (S10), and when the output mode is switched from the 2D mode to one of the 3D mode by operating the 3D output setting button 41 by the user (S20). At that time, the 3D television 100 starts outputting the 3D image that is reproduced based on the selected output format. The microcomputer 30 that executes processes of S10 to S20 corresponds to a 3D output processing unit U1 in the present embodiment. In addition, the OSD section 13 superimposes the OSD image on the 3D image based on the input format detected by the format detection section 12 if the superimposition is instructed by the microcomputer 30.

In other words, by actually switching the output mode from the 2D mode to the 3D mode, the SoC superimposes the OSD image based on the input format and the FRC 20 reproduces the 3D image based on the output format, and at the same time the microcomputer 30 judges the output format.

For example, the input format detected by the format detection section 12 is used for judging the output format. In other words, the information concerning the input format is acquired from the format detection section 12, and then it is compared to the output format selected by the user via the remote controller 40 (S30). In the step S30, the microcomputer that judges the correspondence between the input format and the output format corresponds to a format matching judging unit U2 in the present embodiment.

Here, if the input format matches with the output format (S30: MATCH), the output format of the image is fixed to the 3D mode (S40). On the other hand, if the input format does not match with the output format within a predetermined period (S30: MISMATCH), the output mode is returned to the 2D mode by stopping outputting the image in the 3D mode (S50, S60). The microcomputer 30 that executes steps S30 to S60 corresponds to a time out unit U3 in the present embodiment. After the output mode is returned to the 2D mode, the user is informed that the setting of the 3D mode is not correct (S70). In other words, the microcomputer 30 instructs the OSD section 13 to display the OSD image to indicate that the setting of the 3D mode is not correct.

Therefore, when the user sets the 3D mode, the propriety of the setting is judged automatically. Consequently, the output mode is returned to the 2D mode if the setting of the 3D mode is not correct to avoid the situation where both the 3D image and the OSD image to set the 3D mode again cannot be viewed. In addition, the user can surely recognize the situation where the setting of the 3D mode is not correct because it is noticed after the output mode is returned to the 2D mode.

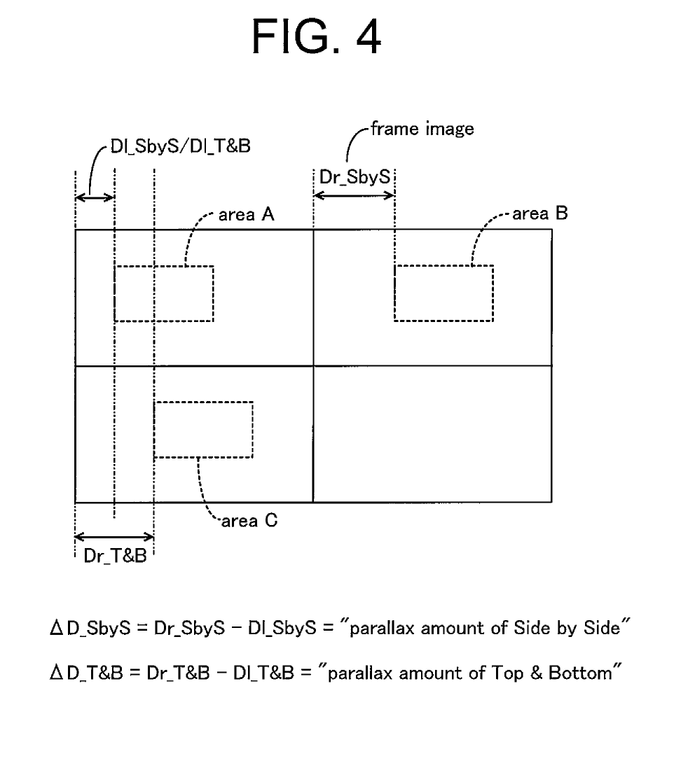

Note that the judgment of the output format can be executed by the method that is shown in FIG. 4. In the method shown in FIG. 4, three areas A to C are specified on the frame image.

The area A is specified in an area where the image of left eye is combined in the frame image of the SbyS. The area B is specified in an area where the image for right eye is combined in the SbyS frame image. Here, the size of the area A and the area B is same, and positions of the areas are adjusted so that the compressed image for left eye included in the area A and the compressed image for right eye included in the area B become almost same. In other words, the difference (ΔD_SbyS) between the distance (D1_SbyS) and the distance (Dr_SbyS) is equal to a parallax amount of the frame image of the SbyS.

In addition, the area A is specified in an area where the image of left eye is combined in the frame image of the T&B. The area C is specified in an area where the image for right eye is combined in the T&B frame image. Here, the size of the area A and the area C is same, and positions of the areas are adjusted so that the compressed image for left eye included in the area A and the compressed image for right eye included in the area C become almost same. In other words, the difference (ΔD_T&B) between the distance (D1_T&B) and the distance (Dr_T&B) is equal to a parallax amount of the frame image of the T&B.

By comparing pixel by pixel the image of the area A and the area B specified as explained above, the input image can be judged whether the SbyS or not. By comparing pixel by pixel the image of the area A and the area C specified as explained above, the format of the input image can be judged whether the T&B or not. Note that the HDMI format doesn't need the method shown in FIG. 4 because the format is surely judged by the tag included in the HDMI 1.4 InfoFrame, but the method can also be applied to the HDMI format.

In other words, if the image included in the area A and the image included in the area B indicates a certain similarity, the input format is judged as the SbyS. On the other hand, if the image included in the area A and the image included in the area C indicates a certain similarity, the input format is judged as the T&B. Note that if both areas of the SbyS and the T&B indicate the certain similarity, the judgment can be repeated until only one of them indicates the certain similarity, or the judgment can be finished by judging a monotone image is input and neither the SbyS nor the T&B is input.

### (3) Second Embodiment for Judging an Output Format

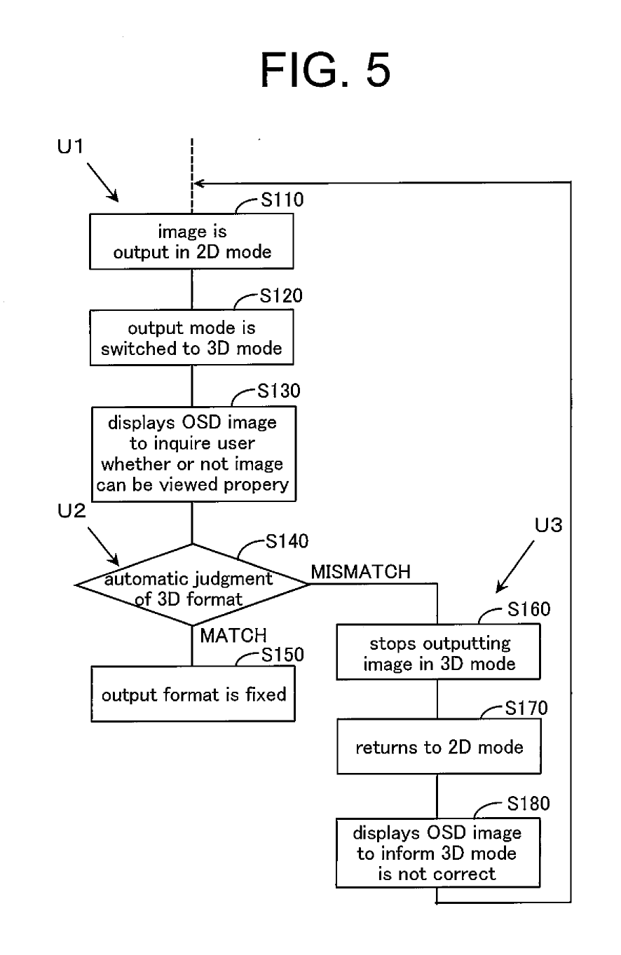

FIG. 5 is a flow chart showing a process of judging an output format in the second embodiment. The judgment of the output format (S130, S140) shown in FIG. 5 is executed while the image is output in the 2D mode (S110), and when the output mode is switched from the 2D mode to one of the 3D mode by operating the 3D output setting button 41 by the user (S120). At that time, the 3D television 100 starts outputting the 3D image that is reproduced based on the selected output format. In addition, the microcomputer 30 instructs the OSD section 13 to superimpose a predefined OSD image (S130), and the OSD section 13 superimposes the OSD image based on the input format detected by the format detection section 12.

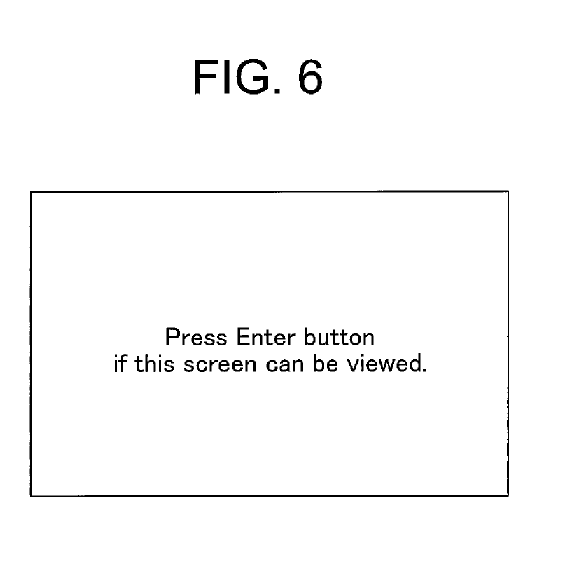

FIG. 6 shows an example of the predefined OSD image displayed in the above step. As shown in FIG. 6, the predefined OSD image inquires the user whether or not the OSD image can be viewed and instructs the user to input a certain operation if the user can view the screen. In an example shown in FIG. 6, the OSD image instructs the user to press the Enter button. If the input format and the output format matches, the user can view the OSD image.

Here, if the user inputs the certain operation by using the remote controller 40 within a predetermined period (S140: YES), the input format and the output format are assumed to match, and the output mode of the image is fixed to the 3D mode (S150). On the other hand, if the user doesn't input the certain operation by using the remote controller 40 within the predetermined period (S140: NO), the input format and the output format are assumed to mismatch, and the output mode is returned to the 2D mode (S160, S170) by stopping outputting the image in the 3D mode. After the output mode is returned to the 2D mode, the user is informed that the setting of the 3D mode is not correct (S180).

In other words, the microcomputer 30 instructs the OSD section 13 to display the OSD image to indicate that the setting of the 3D mode is not correct. Therefore, when the user sets the 3D mode, the propriety of the setting is judged automatically. Consequently, the output mode is returned to the 2D mode if the setting of the 3D mode is not correct to avoid the situation where both the 3D image and the OSD image to set the 3D mode again cannot be viewed. In addition, the user can surely recognize the situation where the setting of the 3D mode is not correct because it is noticed after the output mode is returned to the 2D mode.

### (4) Conclusion

As explained in the above embodiment, in the 3D television 100 that starts outputting the 3D image based on the output mode selected from the user while the image is output in the 2D mode and when the output mode is switched to one of the 3D mode by the user, the 3D television 100 judges the correspondence between the input format and the output format, fixes the output mode to the 3D mode if the input format and the output format matches, or returns the output mode to the 2D mode by stopping outputting the image in the 3D mode if the input format and the output format mismatches. Consequently, the user can avoid the situation where the user cannot view the OSD images even when the setting of the 3D output mode is not correct.

In addition, the above-described basic operation and effect can be obtained even with the apparatus, the method and so on having only the features set forth in the independent claims and having no features set forth in the dependent claims.

Note that, this invention is not limited to the above-mentioned embodiments. Although it is to those skilled in the art, the following are disclosed as the one embodiment of this invention.
Mutually substitutable members, configurations, etc. disclosed in the embodiment can be used with their combination altered appropriately.
Although not disclosed in the embodiment, members, configurations, etc. that belong to the known technology and can be substituted with the members, the configurations, etc. disclosed in the embodiment can be appropriately substituted or are used by altering their combination.
Although not disclosed in the embodiment, members, configurations, etc. that those skilled in the art can consider as substitutions of the members, the configurations, etc. disclosed in the embodiment are substituted with the above mentioned appropriately or are used by altering its combination.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, proximal, distal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

What is claimed is:

1. A stereoscopic image display device comprising:
a 3D output processing unit that receives a selection of a 3D (3-Dimensional) mode as an output format, and changes an output mode to the 3D mode and starts outputting a 3D (3-Dimensional) image based on the selected output format if the selection of the 3D mode is received while an image is output in a 2D (2-Dimensional) mode;
a format matching judging unit that judges a matching between the output format and a format of the image input to the stereoscopic image display device; and
a time out unit that stops outputting the image in the 3D mode to return the output mode to the 2D mode if the format matching judging unit detects a mismatching of the format.

2. The stereoscopic image display device according to claim 1, wherein:
the format matching judging unit judges the format of the image based on a tag information attached to the image input to the stereoscopic image display device.

3. The stereoscopic image display device according to claim 1, wherein:
the format matching judging unit compares an area of a frame image where an image for left eye is to be combined in each 3D format and an area of a frame image where an image for right eye is to be combined in each 3D format by considering an parallax amount, and the 3D format that indicates a certain similarity is judged as the format of the image input to the stereoscopic image display device.

4. The stereoscopic image display device according to claim 1, further comprising:
a first image processing chip that adjusts image quality to the 3D image including a frame image in which an image for left eye and an image for right eye are combined; and
a second image processing chip that reproduces the image for left eye and the image for right eye respectively from the 3D image,
wherein
the first image processing chip superimposes an OSD (On Screen Display) image to the frame image; and
the format matching judging unit superimposes the OSD image that inquires whether or not the OSD image can be viewed on an appropriate position according to the format of the image input to the stereoscopic image display device, and the format is judged to match if a certain operation is input within a certain time after the OSD is displayed and the format is judged to mismatch if a certain operation is not input within a certain time after the OSD is displayed.

5. A 3D television comprising:
a first image processing chip that adjusts image quality to a 3D image including a frame image in which an image for left eye and an image for right eye are combined;
a second image processing chip that reproduces the image for left eye and the image for right eye respectively from the 3D image;
a format reception section that receives a selection of an output format of a 3D (3-Dimentional) mode;
a 3D output processing unit that receives a selection of a 3D mode as an output format, and changes the output format to the 3D mode and starts outputting a 3D image based on the selected output format if the selection of the 3D mode is received while an image is output in a 2D (2-Dimensional) mode;
a format matching judging unit that judges a matching between the output format and a format of the image input to the 3D television; and
a time out unit that fixes the output format to the 3D mode if the format matching judging unit detected the matching of the format, and returns the output format to the 2D mode by stopping outputting the image in the 3D mode if the format matching judging unit detects a mismatching of the format; wherein
the first image processing chip has a format detection section that detects an input format of the 3D image;
the first image processing chip has an OSD section that superimposes an OSD (On Screen Display) image on the frame image based on the input format detected by the format detection section;
the second image processing chip reproduces an image for left eye from an image acquired from a combined area for the image of left eye defined in the output format received by the format reception section, and reproduces an image for right eye from an image acquired from a combined area for the image of right eye defined in the output format received by the format reception section.
